(19) United States
(12) Patent Application Publication
(10) Pub. No.: US 2015/0262501 A1
(43) Pub. Date: Sep. 17, 2015

(54) Continuous User Control of Rapid Serial Visual Presentation of Text

(71) Applicants: David Gerding, Chicago, IL (US); Maurice Rabb, Chicago, IL (US)

(72) Inventors: David Gerding, Chicago, IL (US); Maurice Rabb, Chicago, IL (US)

(73) Assignee: VERBUM, LLC, CHICAGO, IL (US)

(21) Appl. No.: 14/214,657

(22) Filed: Mar. 14, 2014

(51) Int. Cl. G09B 17/04; G06F 3/14; G06F 3/0488; G06F 3/0483; G06F 3/0485

(52) U.S. Cl. CPC G09B 17/04; G06F 3/0483; G06F 3/0485; G06F 3/0488; G06F 3/14; G06F 2203/04808

(57) ABSTRACT

The invention is directed to electronic devices and methods of controlling a user's reading performance, and particularly to providing tactile user control of the user's reading in a rapid serial presentation of texts (“RSVP Text”) system.

### CROSS-REFERENCE TO RELATED APPLICATIONS

This application claims priority benefit under 119(e) to U.S. provisional application Ser. No. 61/791,546, filed 15 Mar. 2013.

### STATEMENT REGARDING FEDERALLY SPONSORED RESEARCH

No federal government funds were used in the research or development of this invention.

### NAMES OF PARTIES TO A JOINT RESEARCH AGREEMENT

None.

### REFERENCE TOA SEQUENCE LISTING

None.

### BACKGROUND

1. Field of the Invention

The invention is directed to electronic devices and methods of controlling a user's reading performance, and particularly to providing tactile user control of the user's reading in a rapid serial presentation of texts (“RSVP Text”) system.

2. Background of the Invention

The technique of Rapid Serial Visual Presentation (RSVP) of text uses mechanical or electronic means to rapidly present a series of glyphs, typically single words or short phrases, one after another and rapidly, to a reading display surface like a computer screen. First demonstrated in non-electronic forms in the early 1970's and electronically in the early 1980's, RSVP held out the promise of dramatically increased effective human reading speeds with minimal user training. RSVP research consistently demonstrated reading speeds three times the typical 250 words per minute for traditional reading, even when reading comprehension is factored against speed.

The Problems

Despite the potential benefits, in the subsequent decades RSVP has failed to attract any substantial user base in the general reading population. This failure to adopt has occurred despite the attendant proliferation in recent decades of screen-based reading and the simultaneous explosion in the quantity of reading material available via the Internet. The problem with RSVP, echoed in the literature, is that the experience of RSVP is “commonly described as unpleasant.” Indeed, a current leading RSVP application vendor warns new users that they “ . . . might feel barely in control . . . ” or that “everything is happening too fast”. Existing RSVP software has placed primacy on achieving the highest speed of reading, as opposed to placing primacy on user control and feedback to enabling both a more pleasurable and improved rate of reading.

### BRIEF SUMMARY OF THE INVENTION

The inventive subject matter claimed and disclosed herein provides a system for presenting and controlling electronic text documents in both standard readable mode and rapid serial visual presentation modes for one or more users, the system comprising a reading control system 100 including: a proceed with reading user affordance subsystem 110 which includes a tactile user input mechanism 111 requiring only very light weight tactile pressure or contact by a user to activate and which, only when activated, emits a proceed signal 112; an attenuate text presentation speed affordance subsystem 120 which includes a variable user input mechanism that emits a range of values that map for that mechanism to a known minimum, a known maximum and a plurality of intermediary values to support user attenuation (increasing and decreasing) and which communicates a requested speed value 113 as the value changes; a reading control system interface 114 that permits outbound data and signaling to a connected plurality of rapid serial visual presentation data systems; a presentation system 200 including: a RSVP display subsystem 210 including: a RSVP display screen 211 capable of screen content refresh rates exceeding 30 frames per second and of sufficient resolution to support readable rendering of single words and short phrases to support effective RSVP text rendering sequences; a RSVP display subsystem interface 214 that permits inbound data and signaling to a connected plurality of rapid serial visual presentation data systems; a computing subsystem 212 including: a processor and stored executable code; a RSVP display rendering subsystem 213, computationally effected on the computing subsystem, and capable of rendering single words and short phrases received via the the RSVP display subsystem interface to the RSVP display screen; a traditional reading display subsystem 220 including; a traditional reading display screen 221 capable of readable rendering of paragraphs of text to support traditional electronic text views; a computing subsystem 222 including: a processor and stored code execution; a traditional reading display subsystem interface 214 that permits inbound data and signaling and is connected to a plurality of rapid serial visual presentation data systems; a traditional reading display rendering subsystem 213, computationally effected on the computing subsystem, and capable of rendering paragraphs of text received via the traditional reading display subsystem interface to the traditional reading display screen; a traditional reading display rendering subsystem 213, computationally effected on the computing subsystem, and capable of rendering a plurality of contextualizing animations that such that the location of the current text quanta in the traditional reading display content is visually communicated as users transition between RSVP and traditional reading; a rapid serial visual presentation data system 300 including: a reading control system communication interface 320 for receiving requested speed values and proceed signals from a plurality of reading control systems; a computing subsystem 350 including: a processor and stored executable code; a RSVP Text Data store 360 for reading and writing structured data representing a plurality of electronic texts; a RSVP rendering control subsystem, computationally effected on the computing subsystem, that renders RSVP to a user by retrieving RSVP Text data and that contains text quanta, single word or short phrase subdivisions of the original plain text identified for this purpose in the RSVP Text data structures and that then sends text quanta, and that sends text quanta, serially over time to a RSVP display subsystem for display; a RSVP rendering control subsystem, computationally effected on the computing subsystem, that ceases RSVP display rendering in the absence of a proceed signal and resumes RSVP display rendering in the presence of a proceed signal; a RSVP rendering control subsystem, computationally effected on the computing subsystem, such that when the proceed signal is interrupted by a user the RSVP rendering control subsystem triggers a plurality of contextualizing animations in the presentation system between the traditional reading display subsystem and the traditional reading display subsystem; a RSVP rendering control subsystem, computationally effected on the computing subsystem, such that when the proceed signal is activated by a user the RSVP rendering control subsystem triggers a plurality of contextualizing animations in the presentation system between the traditional reading display subsystem and the traditional reading display subsystem, such that the location of the current text quanta in the traditional reading display is visually communicated to transition the user from RSVP to a traditional reading context; a presentation system communication interface 310 for communicating with a plurality of presentation systems; a reading control communication interface 370 for communicating with a plurality of presentation systems.

In another preferred embodiment, there is provided wherein the RSVP rendering control subsystem is further adapted to, in the presence of an ongoing proceed signal, continuously determine the amount of time each proceeding text quantum in a text will remain on a display screen of a connected RSVP display subsystem in manner that includes evaluation of the current requested speed value, resulting in a time to render value for that text quantum that is communicated to RSVP display, such that users may continuously and intentionally attenuate the speed of RSVP text presentation but only when the RSVP rendering process is underway.

In yet another preferred embodiment, there is provided the system wherein the rapid serial visual presentation data system and reading control system are further adapted so that data related to changes to the proceed signal and the requested speed signal values and the contemporaneous reading location in the current RSVP Text at the time these data are created, collectively contemplated as RSVP reading telemetry, may be stored for later exploitation to a plurality of user telemetry data stores and where said storage may be local to the user for opportunistic transfer at a later time and or streamed as created in real-time via an existing network connection, the destinations being resolved by a user telemetry data store resource module.

In yet another preferred embodiment, there is provided the system wherein the system is further adapted by the provision of a plurality of render attenuation data, deemed a kind of presentation metadata, where each text quantum may have zero or more associated render attenuation data and where each render attenuation datum includes values available as a coefficient or coefficients that are utilized by one or more time to render evaluations.

In yet another preferred embodiment, there is provided the system wherein the system is further adapted so that render attenuation data set may exist collocated in a memory mechanisms already associated with the RSVP text, for example as an electronic file that may contain all of the text quanta and presentation metadata required for presentation, but also where some are all of the associated render attenuation data may exist in separate memory mechanisms, created at a later time from the original RSVP text data and physically separate from either the related original text quanta and or other related presentation metadata.

In yet another preferred embodiment, there is provided the system wherein the system is further adapted so that a plurality of text section data are provided as components of the presentation metadata associated with an RSVP text, where a text section datum identifies a plurality of text quanta as members of an identified text section which may for example, describe a phrase, quotation or sentence, and where each text section datum may have zero or more associated render attenuation data.

In yet another preferred embodiment, there is provided the system wherein the system is further adapted so that text section data may exist collocated in a memory means already associated with the RSVP text, for example as an electronic file that may contain all of the text quanta and presentation metadata required for presentation, but also where some are all of the associated text section data may exist in separate memory means, created at a later time from the original RSVP text data and physically separate from either the related original text quanta and or other related presentation metadata.

In yet another preferred embodiment, there is provided the system wherein the system is further adapted so that a plurality of meta attenuation data may be provided as components of the presentation metadata associated with an RSVP text and where each meta attenuation datum is associated with a plurality of render attenuation data, such that meta attenuation data are complimentary coefficients available as inputs to the time to render evaluations supporting the ability to influence, as increased or decreased time to render values, the effect a particular set of render attenuation data may have on the rendering process.

In yet another preferred embodiment, there is provided the system wherein the system is further adapted so that where meta attenuation data may exist collocated in a memory means already associated with the RSVP text, for example as an electronic file that may contain all of the text quanta and presentation metadata required for presentation, but also where some are all of the meta attenuation data may exist in separate memory means, created at a later time from the original RSVP text data and physically separate from either the related original text quanta and or other related presentation metadata.

In yet another preferred embodiment, there is provided the system wherein the system is further adapted so that the amount of time a text quantum is displayed to a user during RSVP presentation is determined by evaluating the number of discrete words in the current text quantum and a current target speed in words per minute, as informed by the value provided by the attenuate text presentation speed affordance module, and then applying all applicable coefficients in the related render attenuation data, resulting in each text quanta being displayed on screen for a time either above or below the target speed in words per minute. For example, without the inclusion of render attenuation data the time on screen for 60 words and a target speed of 60 words per minute, assuming each text quantum contained a single word, would be 1 second.

In yet another preferred embodiment, there is provided the system wherein the system is further adapted so that RSVP reading telemetry are used as supervisory metadata such that render attenuation data may be generated from a plurality of supervised machine learning analyses and then applied both to newly created RSVP texts and to already existing RSVP texts.

In yet another preferred embodiment, there is provided the system wherein the system is further adapted so that the specified interfaces for communications wireless network connections rather than physical or compute-bound interfaces so that any combination of the proceed with reading user affordance subsystem, attenuate text presentation speed affordance subsystem, RSVP display subsystem, traditional reading display subsystem and the rapid serial visual presentation data system may be disaggregated physically, permitting a user to control the reading experience with one physical device, experience the traditional reading of the text on a second device and consume the text as RSVP Presentation on a third device.

### BRIEF DESCRIPTION OF THE DRAWINGS

FIG. 1 is a line drawing of a hand with a smart phone device in a series of six frames showing how the touch system actuates the RSVP feature of the device.

FIG. 2 is a line drawing of a hand with a reader device with a rapid reading display in a series of six frames showing how the touch system actuates the RSVP feature of the device.

FIG. 3 is a line drawing of a hand with a combination of devices, here a tablet/reader device and a heads-up-display (HUD) “glasses”-type device in a series of six frames showing how the touch system of the tablet actuates the RSVP feature of the HUD glasses-type device.

FIG. 4 is a line drawing of a text sentence having text quanta values and text presentation metadata values associated therewith.

FIG. 5 is a line drawing of an example of a system provided herein, and shows a reading control system a presentation system and a RSVP text data system in communication with the RCS and PS.

### DETAILED DESCRIPTION OF THE INVENTION

Consistent with the solution provided herein, the invention combines six novel approaches that fundamentally alter and enhance RSVP as an approach to reading. These approaches include: Continuously user-activated serial visual presentation of text; Continuous user-attenuation of the rate of serial presentation of text; Instantaneous transition between serial presentation mode and a plurality of orientation-in-the-text visualizations; Modulating the reading control using a metaphor consistent with the experience of reading using existing paper and electronic artifacts; Modulating the reading control using minimal and consistent means of control, e.g. using a single finger; Exploitation of continuous user attenuation data to adapt subsequent serial presentations; and Continuously User-Activated Serial Visual Presentation of Text.

The fundamental failing of all prior RSVP techniques is the reliance on a primarily passive modality of consumption of the text akin to television and film—that users “watch” a text. After more than a decade of intermittent attempts to adopt existing RSVP techniques for personal use—with each attempt ultimately ending in failure as the cognitive fatigue associated with RSVP overwhelmed our intention to make the most of faster screen-based reading.

Reading a physical book or printed text is not a passive viewing experience like watching a movie in a theatre, it is an active experience bound up in the relationship of our hands to the text and our ability, as a reader, to look away at any moment we choose to collect our thoughts or sip a cup of coffee and immediately regain a sense of our location within the text when we're ready to resume. The sense of overwhelm we experienced with existing RSVP was a function of the fundamental failure of existing solutions to place the reader, as an active agent, at the center of the reading experience.

Provided herein is a mechanism for a continuous requisite user control that requires minimal effort to control the serial visual reading experience and where the serial presentation proceeds only in the presence of this contemporaneous and active user-intention to proceed—a “proceed with reading signal” (also referred to as “the proceed signal” for short). When the proceed signal is interrupted by the user, the rapid serial presentation of the text is paused at the current location in the text, and the user sees the last read word—aka the “current word” oriented within the context of the text. Only while the user provides—and sustains—the proceed signal, does serial presentation and reading proceed. This approach returns absolute control of the reading experience to the reader. The sense of overwhelm typical of existing RSVP application is substantially reduced.

A “document,” as the term is used herein, is to be broadly interpreted to include any machine-readable and machine-storable work product. A document may include, for example, an e-mail, a website, a business listing, a file, a combination of files, one or more files with embedded links to other files, a news group posting, a blog, a web advertisement, a digital map, etc. In the context of the Internet, a common document is a web page. Documents often include textual information and may include embedded information (such as meta information, images, hyperlinks, etc.) and/or embedded instructions (such as Javascript, etc.). A “link,” as the term is used herein, is to be broadly interpreted to include any reference to/from a document from/to another document or another part of the same document.

Computer System Features

As described herein, devices for reading include handheld devices such as cell phones, PDAs, electronic book readers such as the Kindle Fire, tablet computers, mini tablet computers, laptop computers, desktop computers and wearable computing devices. As with all contemplated devices, certain hardware and software systems are required.

A computing system may include a logic subsystem, a data-holding subsystem, a display subsystem, and/or a capture device. The computing system may optionally include peripheral components that are not integrated into the computing system. Logic subsystem may include one or more physical or virtual devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors (CPUs) that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem, or memory, may include one or more physical or virtual devices configured to hold data and/or instructions executable by the logic subsystem to implement the herein described methods and processes. When such methods and processes are implemented, the state of data-holding subsystem may be transformed (e.g., to hold different data). Data-holding subsystem may include removable media and/or built-in devices. Data-holding subsystem may include optical memory devices, semiconductor memory devices (e.g., RAM, EEPROM, flash, etc.), and/or magnetic memory devices, among others. Data-holding subsystem may include devices with one or more of the following characteristics: volatile, nonvolatile, dynamic, static, read/write, read-only, random access, sequential access, location addressable, file addressable, and content addressable. In some embodiments, logic subsystem and data-holding subsystem may be integrated into one or more common devices, such as an application specific integrated circuit or a system on a chip.

The data-holding subsystem may also use or incorporate computer-readable removable media, which may be used to store and/or transfer data and/or instructions executable to implement the herein described methods and processes.

A display subsystem may be used to present a visual representation of data held by data-holding subsystem. As the herein described methods and processes change the data held by the data-holding subsystem, and thus transform the state of the data-holding subsystem, the state of display subsystem may likewise be transformed to visually represent changes in the underlying data. The display subsystem includes graphics processing capability either by the logic subsystem, a dedicated graphics processing subsystem, or combination of the two.

It is contemplated that a device and method will utilize various telecommunications technologies for connectivity to a document being read, including communications interfaces, transceivers and protocols necessary for IP4, IP6, WiFi 802.11 a/b/g/n, Bluetooth, GSM networks including EDGE and LTE, CDMA networks including EV-DO and LTE.

As a nonlimiting example, the display is a touch screen display and the reading controller is either within the touch screen environment or utilizes an existing hardware controller/button of the particular device. Such display devices may be combined with logic subsystem and/or data-holding subsystem in a shared enclosure, or such display devices may be peripheral display devices, as are known in the art.

The devices and methods also include network implementations including client-server architectures. Servers may include server entities that access, fetch, aggregate, process, search, and/or maintain documents in a manner consistent with the principles of the invention. Clients and servers may connect to network via wired, wireless, and/or optical connections.

Networks may include one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The PLMN(s) may further include a packet-switched sub-network, such as, for example, General Packet Radio Service (GPRS), Cellular Digital Packet Data (CDPD), or Mobile IP sub-network. While servers may be as separate entities, it may be possible for one or more of the functions to be shared amongst servers. For example, it may be possible that servers 220 and 230 are implemented as a single server. The client/server entity may perform these operations in response to processor executing software instructions contained in a computer-readable medium, such as memory. A computer-readable medium may be defined as a physical or logical memory device and/or carrier wave.

The software instructions may be read into memory from another computer-readable medium, such as data storage device, or from another device via communication interface. The software instructions contained in memory cause processor to perform operations or processes to effectuate the goals of the invention. Alternatively, hardwired circuitry may be used in place of or in combination with software instructions to implement processes consistent with the principles of the invention. Thus, implementations consistent with the principles of the invention are not limited to any specific combination of hardware circuitry and software.

Continuous User-Attenuation of Serial Presentation

To further enhance the reader's control of the experience we provide for a complimentary but independently evaluated user-generated signal that informs the rate of serial presentation.

Various RSVP approaches have algorithmically controlled the rate of word presentation on the screen during serial presentation. These approaches, called adaptive rapid serial presentation in the prior art literature, all fail because despite the ways in which they might mimic natural prosody or meter, they take the agency, the actual and perceived sense of control over the reading experience, away from the user and situate that control in the algorithms.

One exception in the prior art to the passive serial presentation approach was a 2002 experiment known as Speeder Reader. It employed an automobile driving metaphor in an attempt to give control of the reading speed to the user. The invention was composed of a full-size standup arcade style racing game, with the serialized text appearing on the display screen, and complete with a steering wheel and accelerator foot pedal. The foot pedal control provided a mechanism for user control of the rate of speed. Speeder Reader lacked, however, a separate and discrete user input mechanism to instantaneously suspend the serial presentation and a number of other requisite features of our approach

Our approach provides a satisfying serial presentation reading experience by the real-time user attenuation of the rate of display as the primary factor driving serial presentation. We call this user input the “requested speed signal”. The requested speed signal is a variable user signal, one that can continuously attenuate the overall speed, as a words per minute target, for algorithmically adaptive serial presentation of text. The requested speed signal, like the proceed signal, is requisite user input that is contemporaneous with the serial presentation process. While it literally provides real-time attenuation of the reading experience the tactile nature of these inputs in the typical embodiments presented below provide an important psychological reinforcement to the reader that they are in control of the reading experience.

Our solution requires no special or expensive control equipment nor mechanical affordances like moving parts of any kind, relying on a single finger on a touch screen affordance of a smart phone in one embodiment, for example, for control. In this example, the crucial act of stopping the flow of words can be achieved by lifting one's finger away from the surface, while the proceed signal and speed signal are concurrently rendered, respectively, by the user maintaining contact with the screen while effecting a sliding gesture to attenuate the target rate of speed.

Orientation Visualizations

By requiring the reader to actively signal the forward motion of the serial presentation at all times we enforce an interaction dynamic that further remediates another complaint of RSVP reading—the lack of orientation within the text as a mental model that can be meaningfully sustained by the user.

Specifically, our approach calls for the rendering of an orienting visualization that provides the context of the current word within the larger text whenever the user proceed signal is interrupted. Put another way we opportunistically treat the absence of the signal to proceed as a signal to transition from the serial text presentation to one or more orienting visualizations (also referred to as contexts). These contexts, contemplated in the embodiments and examples section that follows, provide the anchoring and reliable counterpoint to the serial presentation experience. Each time the user interrupts the serial presentation of text, the current word is visually contextualized in an orienting visualization, restoring an important sense of orientation within the text and consistently reinforcing the requisite mental model of a reader's sense of location within the text as a whole.

Exploitation of User Attenuation Data

Having separated the signal apparatus that indicates the user's intention to read and the user's desired rate of reading, and having made these signals co-requisite to the serial presentation process, we recognize the composite of these data, the user signal data stream, as valuable metadata related to the overall process. We therefore provide data persistence means for the user signal data.

The user signal data is persisted to support the exploitation of the attenuation data in support of the refinement of adaptive serial visual presentation algorithms. For example, user attenuation data that throttles down the rate of presentation may correlate over time with specific words or phrases, enabling subsequent rendering algorithms to use previous user behavior to subtly and preemptively attenuate the reading speed for those words or phrases upward or downward, in pursuit of a more comfortable reading experience. These stored user signal data may be exploited both in the aggregate, for general and specific classes of users, or even for individual users, resulting in customized adaptive serial presentation rendering algorithms informed by a history of user interaction.

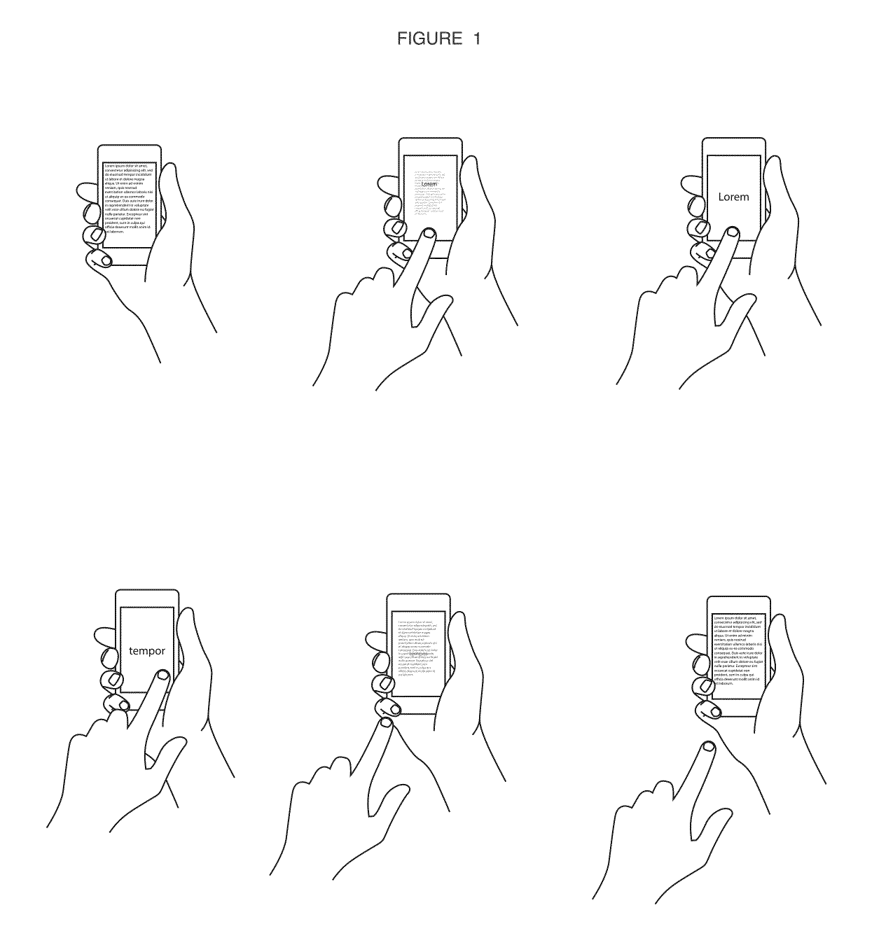

Referring now to the figures, FIG. 1 is a line drawing of a hand with a smart phone device in a series of six frames showing how the touch system actuates the RSVP feature of the device. FIG. 1a-b-c shows how a user actuates or starts an RSVP feature or system on a smart phone. FIG. 1d-e-f shows how when the user removes their finger from the touch screen or control button, that the device interrupts the RSVP processing and reverts back to the text display.

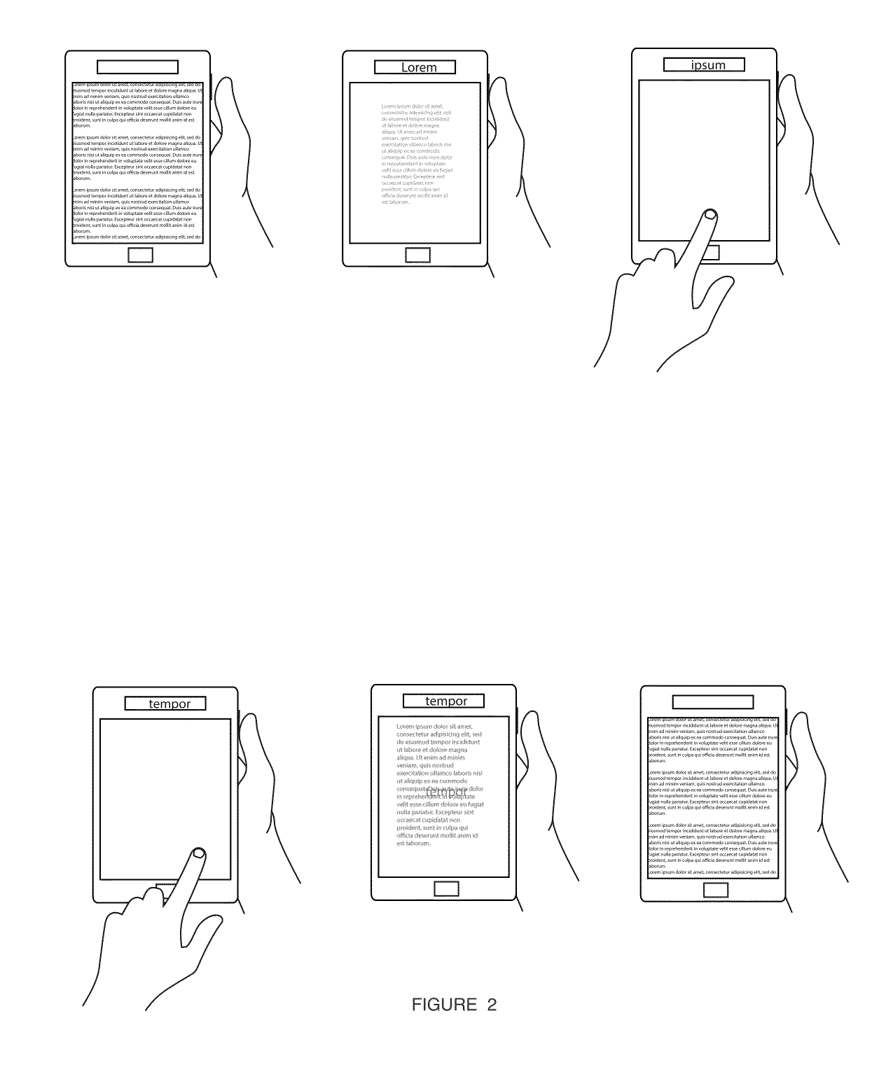

FIG. 2 is a line drawing of a hand with a tablet/reader device with a rapid reading display in a series of six frames showing how the touch system actuates the RSVP feature of the device. FIG. 2a-b-c shows how a user actuates or starts an RSVP feature or system on a tablet/reader device with a rapid reading display. FIG. 2d-e-f shows how when the user removes their finger from the touch screen or control button, that the device interrupts the RSVP processing and reverts back to the text display.

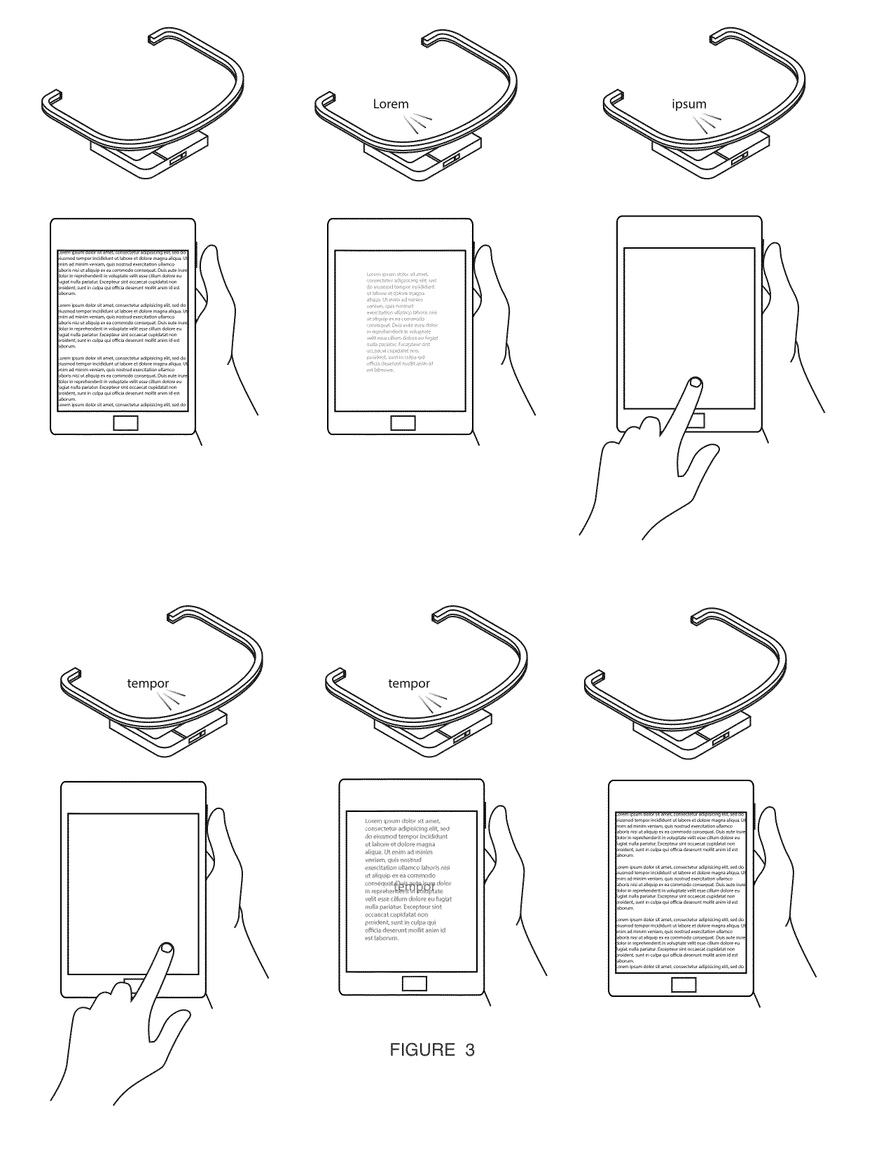

FIG. 3 is a line drawing of a hand with a combination of devices, here a tablet/reader device and a heads-up-display (HUD) “glasses”-type device in a series of six frames showing how the touch system of the tablet actuates the RSVP feature of the HUD glasses-type device. FIG. 3a-b-c shows how a user actuates or starts an RSVP feature or system on a combination tablet/reader device and a heads-up-display (HUD) “glasses”-type device. FIG. 3d-e-f shows how when the user removes their finger from the touch screen or control button, that the device interrupts the RSVP processing and reverts back to the text display.

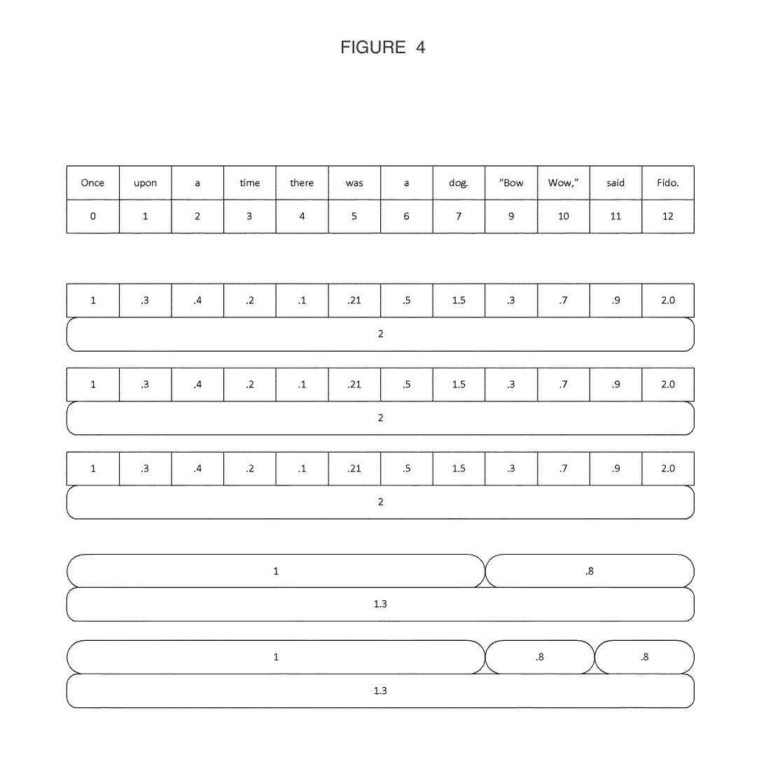

FIG. 4 is a line drawing of a text sentence having text quanta values and text presentation metadata values associated therewith.

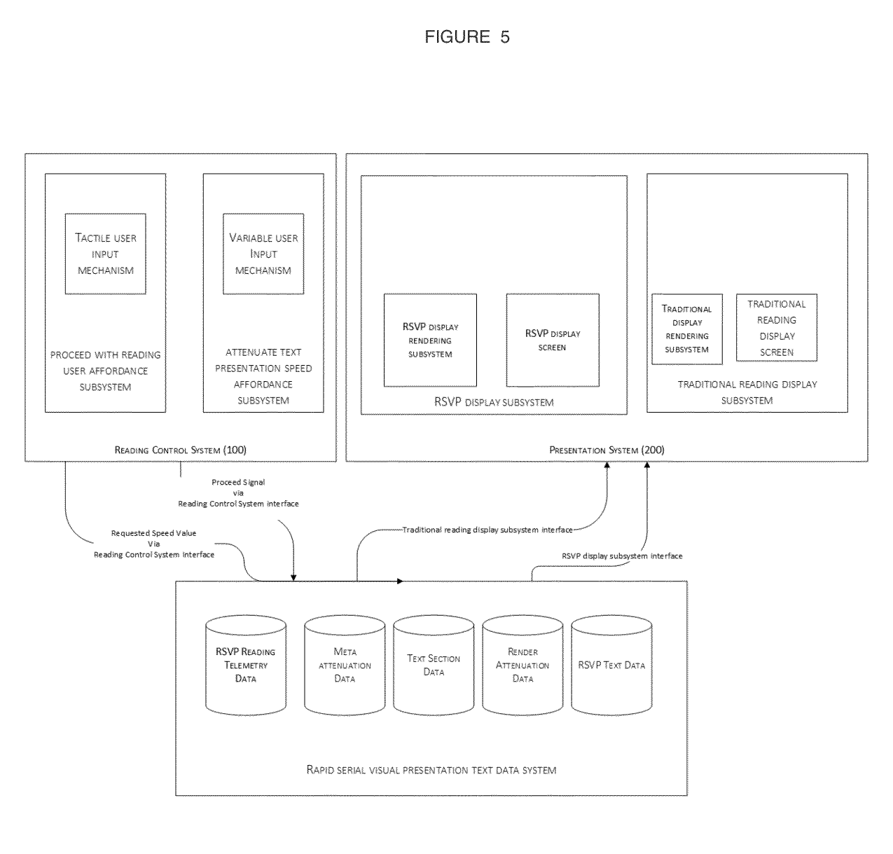

FIG. 5 is a line drawing of an example of a system provided herein, and shows a reading control system a presentation system and a RSVP text data system in communication with the RCS and PS.

### Embodiments and Examples

In this system a serial visual presentation mechanism provides the electronic means of rendering a whole text incrementally, as individual words or phrases, from an electronic storage device to a reading display surface, such as a screen, through a process of serial visual presentation of the words and phrases in an area on a reading surface on which a user will fixate his or her gaze.

The serial visual presentation mechanism is activated only when a proceed signal is provided by the user. It is important to note that the proceed signal is, by design, a signal continuously provided by the user to activate the serial presentation. The absence of the signal is equivalent, functionally, to a signal by the user to deactivate the serial presentation. The absence of the proceed signal is analogous to looking away from or disengaging from the active reading of a text.

Components common to all embodiments include: Rapid serial visual presentation data system; Reading Display; Orienting Visualization Context Display; Go Affordance (provides “proceed with reading signal”) accessible to the reader and connected directly or wirelessly to the Rapid serial visual presentation data system; Speed Affordance (provides the requested speed signal) accessible to the reader connected directly or wirelessly to the Serial Visual Presentation Module; Storage and/or forwarding means for User Attenuation Data Exploitation.

Watch Display Reading Experience

In this experience the reading surface is an electronic wristwatch display. In one version of this experience the watch has a button and a toggle that act as the Go Affordance and Speed Affordance, respectively. In another version of this experience a smart phone screen provides a go signal affordance and a speed throttle affordance using the touch screen. In another version of this experience a dedicated device worn on the finger like a ring and connected wirelessly to the serial visual presentation mechanism provides the go signal and speed throttle affordances. In yet another version of this experience the Go Affordance and Speed Affordance, respectively, are provided using signals provided by a sensor in the watch detecting wrist flection using GSR or related biometric approaches.

In another version of this experience in the event the watch display is insufficient to render the orienting visualizations they are instead presented on a secondary screen device like a smart phone screen.

Wearable Heads-Up Display Reading Experience Example

In this experience the reading surface is a wearable heads-up display (HUD). In one version of this experience a smart phone screen provides a go signal affordance and a speed throttle affordance. In another version of this experience a dedicated device worn on the finger like a ring and connected wirelessly to the serial visual presentation mechanism provides the go signal and speed throttle affordances. In another version of this experience in the event the HUD display is insufficient to render the orienting visualizations they are instead presented on a secondary screen device like a mobile phone.

Mobile Device Experience Example

In this experience the reading surface is provided by the primary screen of a portable electronic device like a smart phone. The touch surface of the screen is leveraged as both the Go Affordance and Speed Affordance and the screen is also utilized as an Orienting Visualizations Display.

Gaming Console Reading Experience Example

In this experience the reading surface and orienting visual display is a living room television and both the Go Affordance and Speed Affordance are provided by leveraging continuous activation of a gaming console controller button and throttle stick, respectively.

Desktop Computing Experience Example

In this experience the reading surface and orienting visual display is a desktop computer display and the Go Affordance is the left mouse button and the Speed Affordance is the mouse wheel or a mouse sliding gesture, respectively.

Enhanced E-Reader Experience

In this experience an e-reader using e-ink display technology adapted to support the invention by the inclusion of a secondary display device capable of high speed rendering requisite for RSVP presentation. Currently, e-ink technologies excel at text render and high contrast, but as contemplated in our separation of the reading area and RSVP rendering area, . . . LCD

Other Experiences

It is understood that it is within the scope of the present invention to use various combinations of devices, including with a smart Watch, a smart Watch & a Phone, a HUD device, a HUD device & Phone, a HUD device & Watch, and so forth.

### PARTIAL PARTS LIST

Reading control system 100
a proceed with reading user affordance subsystem 110
111
Proceed signal 112
Requested speed value 113
an attenuate text presentation speed affordance module 120
130
131
Presentation system 200
210 rapid serial visual presentation display subsystem
211 RSVP display screen
212 rsvp computing subsystem
213 rapid serial visual presentation rendering subsystem
214 interface
traditional reading display module 220
traditional reading display screen 221
222 Computing subsystem
223 Computing subsystem
Rapid serial visual presentation text data system 300
means of communication with a presentation system 310
means of communication 320
RSVP Data Store 330
RSVP Text data format 330 that supports both data supporting traditional reading modes and a plurality of presentation metadata that supports rapid serial visual presentation reading including the identification of subdivisions of text suitable for RSVP presentation, text quanta, typically one word to short phrase per text quantum;
presentation metadata 331
render attenuation data 332
text section data 333
RSVP text data resource module 334
RSVP text generation resource module 335
RSVP reading telemetry 340
user telemetry data store 341
user telemetry data store resource module 342
350 Computing subsystem
360 RSVP display subsystem for display;

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

1. A system for presenting and controlling electronic text documents in both standard readable mode and rapid serial visual presentation modes for one or more users, the system comprising:
a reading control system 100 including:
a proceed with reading user affordance subsystem 110 which includes a tactile user input mechanism 111 requiring only very light weight tactile pressure or contact by a user to activate and which, only when activated, emits a proceed signal 112;
an attenuate text presentation speed affordance subsystem 120 which includes a variable user input mechanism that emits a range of values that map for that mechanism to a known minimum, a known maximum and a plurality of intermediary values to support user attenuation (increasing and decreasing) and which communicates a requested speed value 113 as the value changes;
a reading control system interface 114 that permits outbound data and signaling to a connected plurality of rapid serial visual presentation data systems
a presentation system 200 including:
a RSVP display subsystem 210 including:
a RSVP display screen 211 capable of screen content refresh rates exceeding 30 frames per second and of sufficient resolution to support readable rendering of single words and short phrases to support effective RSVP text rendering sequences;
a RSVP display subsystem interface 214 that permits inbound data and signaling to a connected plurality of rapid serial visual presentation data systems
a computing subsystem 212 including:
a processor and stored executable code;
a RSVP display rendering subsystem 213, computationally effected on the computing subsystem, and capable of rendering single words and short phrases received via the the RSVP display subsystem interface to the RSVP display screen;
a traditional reading display subsystem 220 including;
a traditional reading display screen 221 capable of readable rendering of paragraphs of text to support traditional electronic text views;
a computing subsystem 222 including:
a processor and stored executable code;
a traditional reading display subsystem interface 214 that permits inbound data and signaling and is connected to a plurality of rapid serial visual presentation data systems
a traditional reading display rendering subsystem 213, computationally effected on the computing subsystem, and capable of rendering paragraphs of text received via the traditional reading display subsystem interface to the traditional reading display screen;
a traditional reading display rendering subsystem 213, computationally effected on the computing subsystem, and capable of rendering a plurality of contextualizing animations that such that the location of the current text quanta in the traditional reading display content is visually communicated as users transition between RSVP and traditional reading.
a rapid serial visual presentation data system 300 including:
a reading control system communication interface 320 for receiving requested speed values and proceed signals from a plurality of reading control systems;
a computing subsystem 350 including:
a processor and stored executable code;
a RSVP Text Data store 360 for reading and writing structured data representing a plurality of electronic texts;
a RSVP rendering control subsystem, computationally effected on the computing subsystem, that renders RSVP to a user by retrieving RSVP Text data and that contains text quanta, single word or short phrase subdivisions of the original plain text identified for this purpose in the RSVP Text data structures and that then sends text quanta, and that sends text quanta, serially over time to a RSVP display subsystem for display;
a RSVP rendering control subsystem, computationally effected on the computing subsystem, that ceases RSVP display rendering in the absence of a proceed signal and resumes RSVP display rendering in the presence of a proceed signal;
a RSVP rendering control subsystem, computationally effected on the computing subsystem, such that when the proceed signal is interrupted by a user the RSVP rendering control subsystem triggers a plurality of contextualizing animations in the presentation system between the traditional reading display subsystem and the traditional reading display subsystem;
a RSVP rendering control subsystem, computationally effected on the computing subsystem, such that when the proceed signal is activated by a user the RSVP rendering control subsystem triggers a plurality of contextualizing animations in the presentation system between the traditional reading display subsystem and the traditional reading display subsystem, such that the location of the current text quanta in the traditional reading display is visually communicated to transition the user from RSVP to a traditional reading context;
a presentation system communication interface 310 for communicating with a plurality of presentation systems;
a reading control communication interface 370 for communicating with a plurality of presentation systems;

2. The system of claim 1, wherein the RSVP rendering control subsystem is further adapted to, in the presence of an ongoing proceed signal, continuously determine the amount of time each proceeding text quantum in a text will remain on a display screen of a connected RSVP display subsystem in manner that includes evaluation of the current requested speed value, resulting in a time to render value for that text quantum that is communicated to RSVP display, such that users may continuously and intentionally attenuate the speed of RSVP text presentation but only when the RSVP rendering process is underway.

3. The system of claim 2, wherein the rapid serial visual presentation data system and reading control system are further adapted so that data related to changes to the proceed signal and the requested speed signal values and the contemporaneous reading location in the current RSVP Text at the time these data are created, collectively contemplated as RSVP reading telemetry, may be stored for later exploitation to a plurality of user telemetry data stores and where said storage may be local to the user for opportunistic transfer at a later time and or streamed as created in real-time via an existing network connection, the destinations being resolved by a user telemetry data store resource module.

4. The system of claim 3 wherein the system is further adapted by the provision of a plurality of render attenuation data, deemed a kind of presentation metadata, where each text quantum may have zero or more associated render attenuation data and where each render attenuation datum includes values available as a coefficient or coefficients that are utilized by one or more time to render evaluations.

5. The system of claim 4 wherein the system is further adapted so that render attenuation data set may exist collocated in a memory mechanisms already associated with the RSVP text, for example as an electronic file that may contain all of the text quanta and presentation metadata required for presentation, but also where some are all of the associated render attenuation data may exist in separate memory mechanisms, created at a later time from the original RSVP text data and physically separate from either the related original text quanta and or other related presentation metadata.

6. The system of claim 4 wherein the system is further adapted so that a plurality of text section data are provided as components of the presentation metadata associated with an RSVP text, where a text section datum identifies a plurality of text quanta as members of an identified text section which may for example, describe a phrase, quotation or sentence, and where each text section datum may have zero or more associated render attenuation data.

7. The system of claim 6 wherein the system is further adapted so that text section data may exist collocated in a memory means already associated with the RSVP text, for example as an electronic file that may contain all of the text quanta and presentation metadata required for presentation, but also where some are all of the associated text section data may exist in separate memory means, created at a later time from the original RSVP text data and physically separate from either the related original text quanta and or other related presentation metadata.

8. The system of claim 4 wherein the system is further adapted so that a plurality of meta attenuation data may be provided as components of the presentation metadata associated with an RSVP text and where each meta attenuation datum is associated with a plurality of render attenuation data, such that meta attenuation data are complimentary coefficients available as inputs to the time to render evaluations supporting the ability to influence, as increased or decreased time to render values, the effect a particular set of render attenuation data may have on the rendering process.

9. The system of claim 8 wherein the system is further adapted so that where meta attenuation data may exist collocated in a memory means already associated with the RSVP text, for example as an electronic file that may contain all of the text quanta and presentation metadata required for presentation, but also where some are all of the meta attenuation data may exist in separate memory means, created at a later time from the original RSVP text data and physically separate from either the related original text quanta and or other related presentation metadata.

10. The system of claim 4 wherein the system is further adapted so that the amount of time a text quantum is displayed to a user during RSVP presentation is determined by evaluating the number of discrete words in the current text quantum and a current target speed in words per minute, as informed by the value provided by the attenuate text presentation speed affordance module, and then applying all applicable coefficients in the related render attenuation data, resulting in each text quanta being displayed on screen for a time either above or below the target speed in words per minute. For example, without the inclusion of render attenuation data the time on screen for 60 words and a target speed of 60 words per minute, assuming each text quantum contained a single word, would be 1 second.

11. The system of claim 4, wherein the system is further adapted so that RSVP reading telemetry are used as supervisory metadata such that render attenuation data may be generated from a plurality of supervised machine learning analyses and then applied both to newly created RSVP texts and to already existing RSVP texts.

12. The system of claim 1 wherein the system is further adapted so that the specified interfaces for communications wireless network connections rather than physical or compute-bound interfaces so that any combination of the proceed with reading user affordance subsystem, attenuate text presentation speed affordance subsystem, RSVP display subsystem, traditional reading display subsystem and the rapid serial visual presentation data system may be disaggregated physically, permitting a user to control the reading experience with one physical device, experience the traditional reading of the text on a second device and consume the text as RSVP Presentation on a third device.
